(19) United States
(12) Patent Application Publication
(10) Pub. No.: US 2024/0278544 A1
(43) Pub. Date: Aug. 22, 2024

(54) ENGINEERED WOOD ADHESIVES AND ENGINEERED WOOD PRODUCT THEREFROM

(71) Applicant: CARGILL, INCORPORATED, Wayzata, MN (US)

(72) Inventors: David Edward GARLIE, Eau Claire, WI (US); Flave Eugene MARKLAND, JR., Atkins, IA (US); Shuang ZHOU, Marion, IA (US)

(73) Assignee: CARGILL, INCORPORATED, Wayzata, MN (US)

(21) Appl. No.: 18/564,975

(22) PCT Filed: Dec. 23, 2021
(86) PCT No.: PCT/US2021/065101

§ 371 Date: Nov. 28, 2023

Related U.S. Application Data
(60) Provisional application No. PCT/US21/34906, filed on May 28, 2021.

(51) Int. Cl. B32B 21/02; B32B 21/13; B32B 38/00

(52) U.S. Cl. CPC B32B 21/02; B32B 21/13; B32B 2038/0076; B32B 2260/025; B32B 2260/046; B32B 2264/067; B32B 2309/02

(57) ABSTRACT

According to various aspects of the instant disclosure, a multi-layer engineered wood product can include a first face layer, a second face layer, and a core layer disposed between the first face layer and the second face layer. At least one of the first face layer, the second face layer, and the core layer include a plurality of wood components and a reaction product of a binder reaction mixture dispersed about the plurality of wood components. The mixture of the wood components and binder reaction mixture has a moisture content in a range of 9 wt % to 20 wt %.

### CROSS-REFERENCE TO RELATED APPLICATIONS

This application claims the benefit of PCT Patent Application No. PCT/US2021/034906, filed May 28, 2021, which is incorporated by reference herein in its entirety.

### BACKGROUND

The most commonly used wood adhesives are phenol-formaldehyde resins (PF) and urea-formaldehyde resins (UF). There are at least two concerns with PF and UF resins. First, volatile organic compounds (VOC) are generated during the manufacture and use of lignocellulosic-based composites. An increasing concern about the effect of emissive VOC, especially formaldehyde, on human health has prompted a need for more environmentally acceptable adhesives. Second, PF and UF resins are made from petrochemical products (e.g., petroleum-derived products or natural gas derived products). The reserves of petroleum are naturally limited. The wood composite industry would greatly benefit from the development of formaldehyde-free adhesives made from renewable natural resources.

### SUMMARY OF THE INVENTION

According to various aspects of the instant disclosure, a multi-layer engineered wood product can include a first face layer, a second face layer, and a core layer disposed between the first face layer and the second face layer. At least one of the first face layer, the second face layer, and the core layer include a plurality of wood components and a reaction product of a binder reaction mixture dispersed about the plurality of wood components. The binder reaction is added in a range of from 3 parts to 25 parts per 100 parts of the dry weight of the plurality of wood components. A mixture of the wood components and the binder reaction mixture has a moisture content in a range of 9 wt % to 20 wt %. The binder reaction mixture includes an aqueous portion that includes a polyol component that is added in a range of from 5 wt % to 65 wt % or 5 wt % to 50 wt % based on the dry weight of the binder reaction mixture. The polyol component includes glycerol, an oligomer of glycerol, optionally a monosaccharide, optionally sucrose, sorbitol, or a mixture thereof. The binder reaction mixture further includes a polypeptide-containing component that is added in a range of from 20 wt % to 85 wt % based on the dry weight of the binder reaction mixture. The polypeptide-containing component incudes a vegetable protein. The binder reaction mixture further includes a base in a range of from 0.5 to 15 wt % based on the dry weight of the binder reaction mixture. Optionally, the binder reaction mixture includes a tackifier in a range of from 0.001 wt % to 1.5 wt % of the binder reaction mixture. Optionally, the binder reaction mixture includes sodium sulfite, sodium bisulfite, sodium metabisulfite, or a mixture thereof in a range of from 0.5 wt % to 10 wt % based on a dry weight of the binder reaction mixture. Optionally, the binder reaction mixture includes borax in a range of from 1 wt % to 15 wt % based on the dry weight of the binder reaction mixture.

According to further aspects of the present disclosure, a method of making a multi-layer engineered wood product includes (a) mixing, a polyol component, water, a base, optionally a tackifier, optionally sodium sulfite, sodium bisulfite, sodium metabisulfite, or a mixture thereof; and optionally borax to produce a first mixture. The polyol component comprises glycerol, an oligomer of glycerol, optionally a monosaccharide, optionally sucrose, sorbitol, or a mixture thereof. The method further includes (b) mixing the first mixture produced at (a) with a plurality of wood components to obtain a second mixture or mixing the first mixture produced at (a) with a polypeptide-containing component comprising a vegetable protein to obtain a third mixture. The method further includes (c) mixing the second mixture produced at (b) with a polypeptide-containing component comprising a vegetable protein to form a fourth mixture or mixing the third mixture produced at (b) with a plurality of wood components to form a fifth mixture to form a first engineered wood precursor. The method further includes (d) repeating (a)-(c) at least once to form a second engineered wood precursor. The method further includes (e) stacking the first engineered wood precursor and the second engineered wood precursor with a third engineered wood precursor, the third engineered wood precursor, optionally, formed according to (a)-(c). The method further includes (f) curing the first engineered wood precursor, second engineered wood precursor, and third engineered wood precursor.

According to further aspects of the present disclosure, a method of making a multi-layer engineered wood product includes (a) mixing, a polyol component, water, a base, optionally a tackifier, optionally sodium sulfite, sodium bisulfite, sodium metabisulfite, or a mixture thereof; and optionally borax to produce a first mixture. The polyol component comprises glycerol, an oligomer of glycerol, optionally a monosaccharide, optionally sucrose, or a mixture thereof. The method further includes (b) mixing the first mixture produced at (a) with a plurality of wood components to obtain a second mixture or mixing the plurality of wood components with a polypeptide-containing component comprising a vegetable protein to obtain a third mixture. The method further includes (c) mixing the second mixture produced at (b) with a polypeptide-containing component comprising a vegetable protein to form a fourth mixture or mixing the third mixture produced at (b) with the first mixture produced at (a) to form a fifth mixture to form a first engineered wood precursor. The method further includes (d) repeating (a)-(c) at least once to form a second engineered wood precursor. The method further includes (e) stacking the first engineered wood precursor and the second engineered wood precursor with a third engineered wood precursor, the third engineered wood precursor, optionally, formed according to (a)-(c). The method further includes (f) curing the first engineered wood precursor, second engineered wood precursor, and third engineered wood precursor.

Typically, during curing, a platen is heated to a temperature of at least 100° C., for example, at least 120° C., or at least 187° C. in a range of from 100° C. to 250° C., in a range of from 180° C. to 220° C. or in a range of from 120° C. to 190° C. In some examples, the platen is heated to achieve a curing temperature of at least 198° C., at least 204° C., at least 246° C. in a range of from 198° C. to 232° C., 204° C. to 226° C., 210° C. to 221° C., less than 315° C., or preferably less than 230° C. Typically the platen is heated to achieve a curing temperature in a range of from 204° C. to 248° C., 210° C. to 243° C., 210° C. to 226° C., at least 215° C., or at least 251° C.

As used herein “mixing” means that the components are combined or added to each other to effect combination. For example, “mixing” can include spraying at least one component to another component. For example, “mixing” can include stirring a plurality of the components.

As used herein “mixture” means a portion of matter including two or more chemical substances.

Wood particles used in face layers typically have a lower average aspect ratio than the wood particles used in the core layer. Additionally, the wood particles used in face layers 102 and 104 have a smaller average particle size than the wood particles used in core layer 106. Smaller wood particles in the face layers result in the face layers having a higher density than the core layer. It is expected that the density of the first face layer, second face layer or both is higher than a density of the core layer.

### BRIEF DESCRIPTION OF THE FIGURES

The drawings illustrate generally, by way of example, but not by way of limitation, various embodiments of the present invention.

FIG. 1 is a side-sectional view of a multi-layered engineered wood product according to various aspects of the present patent application.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section.

The term “substantially” as used herein refers to a majority of, or mostly, as in at least about 90%, 95%, 99.5%, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or about 0 wt %.

According to various aspects of the instant disclosure, a multi-layered engineered wood product is described. The multi-layered engineered wood product can typically take the form of a particle board, medium density fiber board, high density fiberboard, oriented strand board, multi-layered engineered wood flooring, and combinations thereof. The multi-layered engineered wood product typically is sized to have any suitable dimensions. For example, the multi-layered engineered wood product typically is sized to be 1.2 meters wide and 2.6 meters long, or 1.3 meters wide and 2.1 meters long. A thickness of the multi-layered engineered wood product typically is in a range of from 1.5 cm to 2.5 cm or 1.8 cm to 2.1 cm. These dimensions are merely meant to be examples and do not limit the sizes of multi-layered engineered wood products that typically are produced.

According to various aspects of the instant disclosure a density of the multi-layered engineered wood product typically is in a range of from 0.2 g/cm³ to 0.8 g/cm³, 0.60 g/cm³ to 0.75 g/cm³, 0.65 g/cm³ to 0.75 g/cm³, or from 0.65 g/cm³ to 0.70 g/cm³.

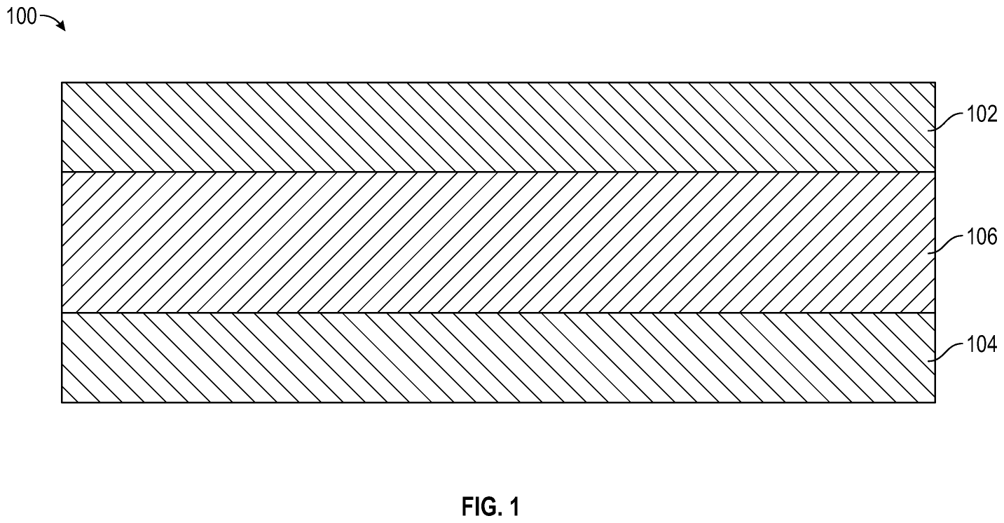

FIG. 1 is a side-sectional view of a multi-layered engineered wood product 100 according to various aspects of the present patent application. As shown in FIG. 1, multi-layered engineered wood product 100 includes first face layer 102 and second face layer 104 with core layer 106 bounded therebetween. A thickness of each of layers 102, 104, and 106 typically is the same or different. In some aspects core layer 106 accounts for 50% to 80% or 50% to 75% of the total thickness of multi-layered engineered wood product 100 or 60% to 70% of multi-layered engineered wood product 100. In some aspects first face layer 102 and second face layer 104 independently account for 10% to 25% or 12.5% to 25% of the total thickness of multi-layered engineered wood product 100 or 15% to 20%. Although three layers are shown, it is possible for multi-layered engineered wood product 100 to have additional layers. Thus, the teachings with respect to first face layer 102, second face layer 104, and core layer 106 can apply to any additional layers not specifically described herein.

First face layer 102, second face layer 104, and core layer 106 can typically include a variety of constituents. For example, first face layer 102, second face layer 104, and core layer 106 can typically individually include a plurality of wood components bound together by a binder. According to various examples, the binder of at least one individual layer (e.g., layers 102, 104, and 106) is a reaction product of a binder reaction mixture including an at least partially non-dissolved polypeptide component distributed about the binder reaction mixture. In other examples only core layer 106 includes the binder that is reaction product of the binder reaction mixture including the at least partially non-dissolved polypeptide component distributed about the binder reaction mixture (first face layer 102 and second face layer 104 can include an alternative binder). In other examples, core layer 106 can be free of a binder that is the reaction product of the binder reaction mixture including the at least partially non-dissolved polypeptide component distributed about the binder reaction mixture and first face layer 102, second face layer 104, or both can include the binder that is a reaction product of the binder reaction mixture including the at least partially non-dissolved polypeptide component distributed about the binder reaction mixture.

Wood particles used in face layers 102 and 104 typically have a lower average aspect ratio than the wood particles used in core layer 106. Additionally, the wood particles used in face layers 102 and 104 have a smaller average particle size than the wood particles used in core layer 106. Smaller wood particles in the face layers result in the face layers having a higher density than the core layer. It is expected that the density of the first face layer, second face layer or both is higher than a density of the core layer. Without intending to be bound to any theory, it is thought that the higher density in the face layers, relative to the core layers, may lead to improvement in the overall balance of the physical properties of the engineered wood product.

In the multi-layered engineered wood product, the binder that is the reaction product of the binder reaction mixture, can typically be added in any of layers 102, 104, and 106, individually, in a range of from 3 parts to 25 parts per 100 parts of the dry weight of the wood components of the respective layer, for example, from 4.5 parts to 23.5 parts, 3 parts to 20 parts, or 6 parts to 17 parts or 8 parts to 17 parts per 100 parts of dry weight of the wood components of the respective layer. Having levels of binder in these ranges can contribute to the multi-layered engineered wood product having favorable or desirable physical properties, while effectively minimizing the amount of binder that is needed to bind the plurality of wood components of the respective layers. In some aspects the chemical composition (e.g., the components of the binder reaction mixture and moisture content of the mixture of wood components and binder reaction mixture) of each of layers 102, 104, and 106 typically is similar (e.g., within 1% of each other). Alternatively, the chemical composition (e.g., the components of the binder composition and moisture content of the mixture of wood components and binder reaction mixture) of any one or more of layers 102, 104, and 106 typically is different (e.g., greater than 1% of each other). The binder typically is characterized as a biopolymer.

Examples of desirable physical properties of the multi-layered engineered wood products can include the product's modulus of rupture (MOR), Modulus of Elasticity (MOE), Thickness Swell Percent (Thickness swell %) or a combination thereof. The modulus of rupture of the multi-layered engineered wood product measures the amount of force required to result in rupturing the multi-layered engineered wood product. The modulus of rupture typically is measured, for example, according to ASTM D 1037-06a. While the modulus of rupture value can depend on a variety of factors, including the multi-layered engineered wood product's density, length, width, thickness, or a combination thereof, the modulus of rupture can generally be in a range of from 10 N/mm² to 25 N/mm² or from 12 N/mm² to 20 N/mm² or from 13 N/mm² to 18 N/mm².

The modulus of elasticity is a quantity that measures multi-layered engineered wood product's resistance to being deformed elastically (e.g., non-permanently) when a stress is applied to it. The modulus of elasticity typically is measured, for example, according to ASTM D 1037-06a. While the modulus of elasticity value typically depends on a variety of factors, including the multi-layered engineered wood product's density, length, width, thickness, or a combination thereof, the modulus of elasticity typically is in a range of from 1,378 N/mm² to 2,413 N/mm² or from 1,930 N/mm² to 2,137 N/mm² (for example, 1,965 N/mm² to 2,033 N/mm²).

The thickness swell % is a quantity the measures the multi-layered engineered wood product's resistivity to water penetration. The higher the value, the greater the amount of water that is penetrated. This can result in the multi-layered engineered wood product swelling or otherwise deforming. For example, the multi-layered engineered wood product may expand past a desired amount. This typically is undesirable, if the multi-layered engineered wood product has precise features such as bore holes, flanges, grooves, or the like, that are designed to fit precisely with a corresponding feature on another product. The thickness swell % value typically is measured, for example, according to ASTM D 1037-06a. According to some aspects, the thickness swell % after soaking the multi-layered engineered wood in water for two hours typically is as low as zero. However, other acceptable values include those in a range of from 5% to 50%, from 5% to 45% or from 20% to 40%, measured after soaking the multi-layered engineered wood product in water for two hours.

The internal bond strength is a quantity that measures the strength of an article to resist rupturing in a direction perpendicular to the surface of the article. The internal bond strength typically is measured, for example, by ASTM D 1037-06a. According to some aspects, the internal bond strength of the multi-layered engineered wood product typically is in a range of from 0.1 N/mm² to 0.83 N/mm² or from 0.2 N/mm² to 0.7 N/mm² or from 0.3 N/mm² to 0.6 N/mm².

A benefit, of using the multi-layered engineered wood products formed using the materials and methods described herein, is that the properties of the multi-layered engineered wood products, typically are generally comparable to those of a corresponding multi-layered engineered wood product differing in that it exclusively uses a urea-formaldehyde (UF) binder. Urea-formaldehyde resin is a synthetic resin produced by the chemical combination of formaldehyde (a gas produced from methane) and urea (a solid crystal produced from ammonia). Urea-formaldehyde resins are used mostly for gluing plywood, particleboard, and other wood products. Urea-formaldehyde resins polymerize into permanently interlinked networks, which are influential in the strength of the cured adhesive. After setting and hardening, urea-formaldehyde resins form an insoluble, three-dimensional network and cannot be melted or thermo-formed.

However, there are a number of disadvantages associated with using urea-formaldehyde. For example, addition of water, in high temperature, cured urea-formaldehyde can hydrolyze and release formaldehyde, this weakens the glue bond and can be toxic. Moreover, urea-formaldehyde must be used in a well ventilated area because uncured resin is irritating and can be toxic. Additionally, urea-formaldehyde adhesives generally have a limited shelf life. According to some aspects, however, a urea-formaldehyde resin can be included in a layer of multi-layered engineered wood product 100. For example, a urea-formaldehyde resin or a methylene diphenyl diisocyanate binder (e.g., a pre-polymerized methylene diphenyl diisocyanate, typically referred to as “PMDI”) or a polyamide-epichlorohydrin based binder (typically includes protein) can be located in core layer 106 or in first face layer 102 and/or in second face layer 104.

The materials described herein can address at least some of these drawbacks and, in particular, prevent the outgassing of substantially any formaldehyde. Moreover, according to various aspects, the modulus of rupture, the thickness swell %, modulus of elasticity, or a combination thereof of the multi-layered engineered wood can be substantially similar to a modulus of elasticity, modulus of rupture, a thickness swell %, or a combination thereof of a corresponding multi-layered engineered wood differing in that the reaction product exclusively uses urea-formaldehyde or a methylene diphenyl diisocyanate binder or a polyamide-epichlorohydrin based binder. More specifically, the thickness swell %, modulus of elasticity, modulus of rupture or a combination thereof of the multi-layered engineered wood typically is within 1% to 10%, 1% to 5%, or is substantially identical to the modulus of elasticity, modulus of rupture, the thickness swell %, or a combination thereof of the corresponding multi-layered engineered wood product. However, in further aspect modulus of elasticity, modulus of rupture, the thickness swell %, or a combination thereof typically is within 50% to 150% of the corresponding multi-layered engineered wood product.

The properties of the multi-layered engineered wood products described herein typically is further achieved or enhanced, for example, by distributing the binder such that it is substantially homogenously distributed about the plurality of wood components. Other properties such as the thickness swell % can typically be achieved or enhanced by adding a swell-retardant agent such that it is distributed about the multi-layered engineered wood product. The swell-retardant agent can include a wax emulsion that can sustain (e.g., remain stable) a high pH environment that is greater than 10. Where present, the swell-retardant typically is from 0.1 wt % to 1 wt % or from 0.5 wt % to 0.7 wt % of the multi-layered engineered wood product.

The multi-layered engineered wood product described herein is formed from a multi-layered engineered wood precursor mixture. The multi-layered engineered wood precursor mixture includes at least a plurality of wood components, an aqueous portion of a binder reaction mixture and a polypeptide-containing component distributed about the binder reaction mixture. The plurality of wood components can include one or more wood particles, one or more wood components, or one or more wood strands. The wood components can include a wood material such as pine, hemlock, spruce, aspen, birch, maple, or mixtures thereof.

The aqueous portion of the binder composition has an initial viscosity (prior to curing) at 25° C. of 5 centipoise (cP) to 1,000 cP, from 10 cP to 500 cP, from 50 cP to 300 cP, and where low viscosity is particularly beneficial, from 10 cPs to 100 cP at 25° C. Viscosity is measured using a Brookfield DVI viscometer, available from Brookfield Ametek.

Where present in any of first face layer 102, second face layer 104, or core layer 106, as stated herein above, the binder reaction mixture can typically be added in a range of 3 to 25 parts per one hundred (100) parts of the dry weight of the wood components of the respective layer. The binder composition can typically include a polyol component and a base material. Furthermore, a polypeptide containing component typically is distributed about the binder reaction mixture after the polyol component, base, and wood component(s) are mixed. The polypeptide containing component can typically be substantially non-dissolved.

The polypeptide-containing component can take the form of a solid (e.g., a powder) or can be in the form of a slurry or suspension (e.g., contains both solid and liquid phases).

The polyol component typically is in an aqueous form in a range of from 5 wt % to 65 wt % or 5 wt % to 50 wt % based on a dry weight of the binder reaction mixture or from 10 wt % to 50 wt %, 20 wt % to 50 wt %, 20 wt % to 40 wt %, or 20 wt % to 30 wt %. The polyol component can include glycerol, an oligomer of glycerol, a monosaccharide, sucrose, or a mixture thereof. The glycerol or oligomer of glycerol can include pure glycerol or an oligomer of glycerol. The glycerol component typically comprises at least 80 wt % glycerol on a dry weight basis (for example, at least 85 wt %, at least 90 wt %, or at least 95 wt % on a dry weight basis). In some aspects, the glycerol or oligomer of glycerol is diluted. For example, in some aspects the glycerol component can include a crude glycerol. A crude glycerol can include 30 wt % to 95 wt % glycerol or 55 wt % to 95 wt % glycerol. An exemplary example of a crude glycerol is a mixture including 10 to 20 wt % water (for example 15 wt %), 3 wt % to 7 wt % NaCl (for example 4 wt % to 5 wt %) and 80 wt % to 92 wt % glycerol (for example 87.5 wt %). A crude glycerol may include additional materials known to one of skill in the art. In some aspects, the glycerol can be a technical glycerol that includes a high concentration of glycerol and less than 1 wt % methanol, less than 0.5 wt % methanol, or less than 0.1 wt % methanol and less than 1 wt % NaCl, less than 0.5 wt % NaCl, or less than 0.1 wt % NaCl.

Examples of suitable monosaccharides include a glucose syrup a high fructose corn syrup, or a mixture thereof. In the polyol component. In some aspects, the polyol component includes a glucose syrup, high fructose corn syrup, or a mixture thereof. In some aspects, the glucose syrup can have a dextrose equivalent (DE) of at least 60, at least 80, at least 85, at least 90, or at least 95. As understood herein, dextrose equivalent is a measure of the amount of reducing sugars present in a sugar product, expressed as a percentage on a dry basis relative to dextrose. As used herein, a high fructose corn syrup includes at least 90 wt % fructose and glucose. In some aspects, the high fructose corn syrup can include at least 94 wt % fructose and glucose. In some aspects, the high fructose corn syrup includes from 30 wt % to 70 wt % glucose or from 35 wt % to 65 wt % glucose. In some aspects the binder reaction mixture can include fructose, sucrose, or glucose (or mixtures thereof) in addition to the polyol component. Where added the fructose, sucrose, or glucose (or mixtures thereof) typically is 1 wt % to 30 wt %, 5 wt % to 20 wt %, or preferably 5 wt % to 10 wt %, based on a dry weight of the binder reaction mixture.

The base can typically be added in the binder reaction mixture in a range of from 1 wt % to 15 wt %, 1 wt % to 12 wt % or 3 wt % to 10 wt % based on a dry weight of the binder reaction mixture. The base can typically be added to such a degree that a pH of the aqueous portion of the binder reaction mixture is greater than 10 but less than 14. The pH, therefore, is typically in a range of from 10 to 14 or 11 to 14. Typically, the base includes NaOH, KOH, magnesium oxide, or mixtures thereof. In some aspects the base can include another strong base (for example, Ca(OH)2 or another base that completely dissociates in solution) or sodium carbonate. In some aspects ammonium or ammonia hydroxide can be used as the base, but these are not preferred because of their propensity to generate gaseous ammonia. In some aspects, the base includes solely NaOH. It was found that using a base to achieve these pH values, in particular, led to improvement in the thickness swell %, modulus of rupture, and modulus of elasticity of the resulting multi-layered engineered wood product.

While not intending to be limited to any theory, it is believed that the base, at the disclosed concentrations, results in the high pH environment that enhances the reaction between the polyol component, polypeptide-containing component, and wood component to form a biopolymer network enveloping the wood component. For example, it is believed that the base can help to dissolve at least a portion of individual wood components. This, in turn, allows the binder precursor solution to penetrate at least partially into the interior of the individual wood components. Therefore, when the binder precursor is subjected to curing a greater degree of interlocking between the binder and the individual wood components typically is achieved. The relatively high pH values described herein, are not described in U.S. Pat. No. 8,501,838.

The precursor further includes a polypeptide-containing component distributed about the polyol component and wood component. According to various aspects, the polypeptide-containing component typically is partially non-dissolved. The concentration of polypeptide-containing component is measured based on the dry weight of the binder reaction mixture. The concentration of the polypeptide-containing component can typically be in a range of from 20 wt % to 85 wt %, 30 wt % to 80 wt %, or 40 wt % to 65 wt %.

The polypeptide-containing component can typically include a protein sourced from a vegetable. For example, the protein typically is soy flour, soy meal, soy protein, pea protein, wheat gluten, corn protein isolate, or a mixture thereof. In some aspects, the polypeptide-containing component includes a protein sourced from soy flour. The soy flour typically is from 40 wt % to 65 wt % or 50 wt % to 60 wt %, protein based on the total soy flour added. Where the polypeptide-containing component is a mixture such as a flour, it is possible for it to include non-protein constituents such as a carbohydrate. In these instances, the disclosed concentrations of the carbohydrates in the binder precursor, or reaction product thereof, are independent of the amount of any carbohydrate added from the polyol component. It has been surprisingly and unexpectedly found that mixtures including soy flour produce multi-layered engineered wood products having better properties than a corresponding multi-layered engineered wood products formed with constituents having higher percentages of protein.

In certain aspects, where the polypeptide-containing component includes soy flour, the soy flour can have a protein dispersibility index of at least 60. For example, a protein dispersibility index of the soy flour typically is in a range of from 70 to 95, for example a PDI from 80 to 90. If it is desired to screen the polypeptide-containing component by size, the component typically is selected from one that passes through a screen sized 100-mesh screen to a 635-mesh screen or a 100-mesh screen to a 400-mesh screen, for example a screen size typically is from 150 to 325.

In certain aspects, the multi-layered engineered wood precursor mixture can include sodium sulfite, sodium bisulfite, sodium metabisulfite or a mixture thereof. Where added, the sodium sulfite, sodium bisulfite, sodium metabisulfite, or a mixture thereof is in a range of from 1 wt % to 10 wt % or from 1 wt % to 5 wt %, based on the dry weight of the binder reaction mixture. Including sodium sulfite, sodium bisulfite, sodium metabisulfite, or a mixture thereof can help to increase the strength of the resulting multi-layered engineered wood product. For example, they can help to increase the modulus of rupture, modulus of elasticity, or both of the multi-layered engineered wood product, relative to a corresponding multi-layered engineered wood product that is free of sodium sulfite, sodium bisulfite, sodium metabisulfite, or a mixture thereof. However, in certain aspects, including sodium sulfite, sodium bisulfite, sodium metabisulfite, or a mixture thereof can increase the sulfur content of the multi-layered engineered wood product, which may be detrimental for certain applications.

According to various aspects, the aqueous portion can further include a borax. The term borax is often used for a number of closely related minerals or chemical compounds that differ in their crystal water content. Examples of suitable borax compounds include sodium tetraborate decahydrate (or sodium tetraborate octahydrate), sodium tetraborate pentahydrate, anhydrous sodium tetraborate, and mixtures thereof. Where added, the borax typically is in a range of from 1 wt % to 15 wt % based on the dry weight of the binder reaction mixture or 3 wt % to 6 wt %.

According to various aspects, the binder reaction mixture can further include sodium trimetaphosphate, which typically is added in the binder reaction mixture in a range of from 0.1 wt % to 10 wt %, or 0.4 wt % to 0.9 wt %, or even 0.6 wt % to 0.8 wt %, based on the dry weight of the binder reaction mixture. In some aspects, the preferred range is from 0.7 wt % to 0.9 wt %, based on the dry weight of the binder reaction mixture. Without being limited to any theory, it is understood that including sodium trimetaphosphate can help to allow for higher levels of carbohydrate to be added in the binder reaction mixture. Additionally, it is believed that including sodium trimetaphosphate typically is helpful to increase at least the internal bond strength in an engineered wood produced using the binder reaction mixture. It is also believed that including sodium trimetaphosphate typically is helpful to improve the thickness swell % values of the engineered wood using the binder reaction mixture.

As described previously, the binder is substantially free of a urea-formaldehyde binder or a methylene diphenyl diisocyanate binder or a polyamide-epichlorohydrin based binder. Therefore, the precursors described herein are also free of a urea-formaldehyde binder or a methylene diphenyl diisocyanate binder or a polyamide-epichlorohydrin based binder. For example, the mixture can typically include less than 5 wt % of urea-formaldehyde or a polyamide-epichlorohydrin based binder or be substantially free (e.g., include less than 1 wt %) of urea-formaldehyde or a methylene diphenyl diisocyanate or a polyamide-epichlorohydrin based binder.

The moisture content of a mixture of the binder reaction mixture and the plurality of wood components, prior to curing, used to form each of first face layer 102, second face layer 104, and core layer 106 typically is carefully controlled. For example, the moisture content of the mixture of the wood components and the binder reaction mixture in each of layers 102, 104, and 106, typically is in a range of at least 9 wt % or from 9 wt % to 20 wt % or 9.5 wt % to 16 wt %, or from 10 wt % to 15 wt % preferably the moisture content of the mixture of the wood components and the binder reaction mixture in each layer is at least 9 wt %, at least 9.5 wt %, at least 11 wt % and less than 16 wt % or less than 15 wt %. In some examples the moisture content of the mixture of the wood components and binder reaction mixture of core layer 106 is at least 9 wt % and the moisture content of each of the mixture of the wood components and binder reaction mixture of first face layer 102 and second face layer 104 are individually greater than the moisture content of the mixture of the wood components and binder reaction mixture of core layer 106. In some further examples the moisture content of the mixture of the wood components and the binder reaction mixture of core layer 106 is at least 9 wt % and is greater than that of each of first face layer 102 and second face layer 104. In some further examples the moisture content of the mixture of the wood components and binder reaction mixture of each of first face layer 102, second face layer 104, and core layer 106 are within 5 wt % of each other, within 3 wt % of each other, within 1 wt % of each other, or similar or even the same. The moisture content can affect the ability to disperse the components of the binder reaction mixture about the wood components. The moisture content typically is tuned, for example by increasing or decreasing the moisture content in the binder reaction mixture. For example, if the moisture content in the wood is low, the moisture content in the binder reaction mixture typically is increased to bring the total moisture content of the mixture of the binder reaction mixture and plurality of wood components to a desired level. In some aspects, moisture typically is added to the mixture of the wood components and the binder reaction mixture by spraying water to the binder reaction mixture distributed on the wood components. However, in certain aspects, water can simply be added to the polyol component before it is applied to the wood component. This can give better distribution of the moisture across the mixture of binder reaction mixture and wood components.

As used herein a moisture content means the total moisture content (by weight percent) of the mixture of the wood components and binder reaction mixture. This is referred to in the Examples here in as “WT”. Alternatively, the moisture content of the mixture of the wood components and binder reaction mixture is referred to as a “mat moisture”. As a further alternative, the total moisture content of the wood components and the binder reaction mixture is referred to as the “moisture content of the binder reaction mixture that is applied to the plurality of wood components.

In some examples, any of first face layer 102, second face layer 104, or core layer 106 can individually include a tackifier. Examples of suitable tackifiers can include sucrose, pine rosin, starch, molasses, or a mixture thereof. Where added, the tackifier can range from 1 wt % to 10 wt %, from 2 wt % to 8 wt %, or from 5 wt % to 7 wt % of the binder reaction mixture of first face layer 102, second face layer 104, or core layer 106, individually. When the polyol component comprises glycerol or an oligomer of glycerol, including a tackifier can help to improve the tack of the binder reaction mixture, which can compliment the favorable thickness swell properties provided by glycerol. When the polyol includes fructose, sucrose, or glucose (or mixtures thereof), the tack of the binder reaction mixture may be sufficient and not require an additional tackifier.

The multi-layered engineered wood product described herein typically is made or manufactured according to many suitable methods. As an example, a method can include (a) mixing the polyol component, water, and the base and optionally the tackifier, optionally borax, optionally sodium sulfite, optionally sodium bisulfite, optionally sodium metabisulfite or an optional mixture thereof to produce a first mixture.

After the first mixture of (a) is formed, the method can further include (b) mixing the first mixture produced at (a) with the plurality of wood components to obtain a second mixture. To help to achieve a uniform blend, mixing at (b) is typically performed by spraying the polyol component and base to the plurality of wood components. The spraying and mixing can typically occur for a time in a range of from 1 minute to 60 minutes or 1 minute to 10 minutes.

After mixing at (b) is performed, the method further includes (c) mixing the mixture produced at (b) with the polypeptide-containing component to form a third mixture. The polypeptide-containing component at this stage typically is in a powder form. It has been found that the properties of the resulting multi-layered engineered wood product (e.g., modulus of rupture, modulus of elasticity, thickness swell %, or a combination thereof) are better when the polypeptide-containing component is in powder form as opposed to a dispersion form.

In examples that include fructose, sucrose, or glucose (or mixtures thereof) (e.g., a high-fructose corn syrup) Before performing step (b), the first mixture obtained at (a) typically is used immediately. However, the first mixture obtained at (a) can also be aged for example, for at least 1 hour, or at least 12 hours. And surprisingly and unexpectedly it has been found that the mixture obtained at (a) can effectively be use when aged for 26 hours or greater before performing (b), for example, the first mixture typically is aged for at least 50 hours, at least 120 hours, at least 360 hours, at least 1400 hours, at least 2000 hours, from 26 hours to 1400 hours, or from 50 hours to 360 hours before performing (c). These times typically are reduced by heating the mixture. The step at (c) is typically performed for at least 1 minute, for example in a range of from 1 minute to 60 minutes or from 1 minute to 10 minutes.

The third mixture formed during step (c) exhibits tack properties comparable or improved relative to alternative binder systems (e.g., those using a urea-formaldehyde binder or a methylene diphenyl diisocyanate binder or a polyamide-epichlorohydrin based binder or that include a lower moisture content). Tack is the adhesive property that imparts upon the materials being bound, the ability to lightly stick together with gentle pressure. Tack is typically an important property for maintaining the shape and distribution of wood fibers within the mat during initial formation throughout the particleboard manufacturing process. Increasing the polyol component portion of the aqueous portion of the binder reaction mixture during step (b) appears to visually improve the tack properties of the resulting binder reaction mixture. Adding the tackifier can also help to increase the tack properties.

Steps (a)-(c) create a green structure (resinated furnish) of one of first face layer 102, second face layer 104, or core layer 106. Steps (a)-(c) typically are repeated to create a green structure of a second face layer 104 and core layer 106, if desired. In some aspects at least one layer may be free of the aforementioned binder and can instead include a urea-formaldehyde resin binder or a methylene diphenyl diisocyanate binder or a polyamide-epichlorohydrin based binder. The green structures formed from each series of steps (a)-(c) are stacked. The tack strength of the green structure helps to allow the green structure to remain relatively intact when stacked. Once the stack (mat) is formed, the stack is then cured. Curing can include hot pressing the stack. Hot pressing is performed at a pressure of at least 0.34 N/mm² and at most 3.44 N/mm², from 0.34 N/mm² to 3.1 0.34 N/mm², or from 0.20 N/mm² to 2.75 N/mm². The pressure used typically is selected at least in part to achieve a certain thickness of the multi-layered engineered wood product. In addition to the pressure, a platen of the press used for hot pressing at is heated to a temperature in a range of at least 100° C., for example, at least 120° C., or at least 200° C. in a range of from 100° C. to 250° C., or in a range of from 120° C. to 200° C., or in a range of 120° C. to 190° C., or in a range of 100° C. to 250° C., in a range of from 120° C. to 225° C., or at least 187° C. In some examples, the platen is heated to less than 315° C., preferably less than 230° C., less than 225° C., less than 200° C., less than 190, or less than 180° C.

Typically, the platen is heated to a temperature in of at least 100° C., for example, at least 120° C., or at least 187° C. in a range of from 100° C. to 250° C., in a range of from 180° C. to 220° C. or in a range of from 120° C. to 190° C. In some examples, the platen is heated to achieve a curing temperature of at least 198° C., at least 204° C., at least 246° C. in a range of from 198° C. to 232° C., 204° C. to 226° C., 210° C. to 221° C., less than 315° C., or preferably less than 230° C. Typically the platen is heated to achieve a curing temperature in a range of from 204° C. to 248° C., 210° C. to 243° C., 210° C. to 226° C., at least 215° C., or at least 251° C. .

The method can further include a “cold pressing” step that can occur before or after the hot pressing. Cold pressing can occur at ambient temperatures.

Curing above 100° C. causes water to convert to steam that creates an internal gas pressure in the product, which can ultimately cause the wood product to fail in maintaining structural soundness (e.g., blow). This problem is especially present if a urea-formaldehyde based binder if is used. Surprisingly and unexpectedly, using the instantly disclosed binders, it is possible to cure the engineered wood products at high temperatures (by heating the platen to a high temperature) and high mat moisture content (both within the respective ranges described herein) without causing the product to blow.

Any of the swell-retardant components described herein typically are added to the wood component at any point during the method at step (a), (b), (c), or a combination thereof. Similarly, sodium sulfite, sodium bisulfite, sodium metabisulfite or a mixture thereof typically is added to the method at step (a), (b), (c), or a combination thereof. Similarly, sodium trimetasphosphate typically is added to the method at step (a), (b), (c), or a combination thereof.

The wood component typically is mixed with the aqueous portion to form the first mixture before the wood component is mixed with the polypeptide component as outlined in steps (a), (b), and (c). Alternatively, the wood component typically is mixed with the polypeptide component before it is mixed with any of the constituents of the aqueous portion. It has been found however, that performing at least steps (a), (b), and (c) in sequential order improves the properties in the multi-layered engineered wood product. Specifically, the modulus of rupture, modulus of elasticity, and thickness swell % in the resulting multi-layered engineered wood product are improved as compared to corresponding multi-layered engineered wood products formed in a different order. Without intending to be bound to any theory, it is believed that performing these steps in order helps to achieve an even spread of the polyol component on the wood component. Moreover, the polyol component is at least partially embedded into the wood component by virtue of the base creating openings in the wood component. Thus, when the polypeptide-containing component comes into contact with the polyol component, the reaction between the two is uniform. It was found that including the polypeptide-containing component along with the wood component, base, (and optionally borax, optionally sodium sulfite, optionally sodium bisulfite, optionally sodium metabisulfite or an optional mixture thereof) and polyol component in one step reduced the thickness swell %, modulus of rupture, and modulus of elasticity of the resulting multi-layered engineered wood product.

### Working Examples

Various aspects of the present disclosure can be better understood by reference to the following Working Examples, which are offered by way of illustration. The present disclosure is not limited to the Working Examples given herein. Unless indicated to the contrary, mixtures of the wood components and the binder reaction mixtures used in the examples had a moisture content (e.g., a mat moisture content prior to curing) of from nine percent by weight (9 wt %) to seventeen weight percent (17 wt %) and preferably from nine percent by weight to fifteen percent. Additionally, unless indicated to the contrary, % NaOH, % Prolia 200/90, % Crude Glycerol, % Na₂SO₃, % borax, % IsoClear 42, % MgO, etc. refer to dry weight percent of the indicated component based on the total dry weight of the binder reaction mixture.

| Name | Supplier |
|---|---|
| Wood particles | Wood Particles having an average aspect |
| (WP) | ratio (length: width) of greater than 1:1. Wood |
| | particles used in the face layer typically have |
| | a lower average aspect ratio than the wood |
| | particles used in the core layer. Additionally, |
| | the wood particles used in the face layer have |
| | a smaller average particle size than the wood |
| | particles used in the core layer. |
| Prolia 200/90 | A soy flour having protein content of 52.5 |
| (Soy Flour) | wt % and a 200 mesh particle size and a |
| | polydispersity index (PDI) of 90, available |
| | from Cargill, Incorporated, Wayzata, |
| Crude Glycerol | A mixture including 10-15 wt % water, 3-7 |
| (Crude GLY) | wt % NaCl and 55-95 wt % glycerol, available |
| | from Cargill, Incorporated, Wayzata, MN |
| NaOH | A 50 wt % sodium hydroxide solution |
| | available from Thermo Fischer Scientific, |
| | Waltham, MA |
| Na2SO3 | Sodium sulfite, available from Acros |
| | Organics, Fair Lawn, NJ |
| Na₂B₄O₇•10H₂O | A sodium tetraborate decahydrate borax, |
| (Borax) | available from Thermo Fischer Scientific, |
| | Waltham, MA |
| IsoClear 42 | A high fructose corn syrup comprising 42 |
| | wt % fructose and 52 wt % glucose and 6% |
| | other saccharides, available from Cargill, |
| | Incorporated, Wayzata, MN |
| MgO | Magnesium Oxide, available from Premier |
| | Magnesia, Waynesville, NC |

### Working Example 1: Binder Preparation and Preparation of Multi-Layered Engineered Particle Boards

A pre-weighed amount of water (WA) and 50% alkaline solution such as an NaOH solution are mixed to form a diluted alkaline solution including NaOH, which is allowed to cool down to 25-30° C. Where present, a polyol component such as an IsoClear 42 high fructose corn syrup solution is slowly added to the diluted NaOH solution along optional components such as Na₂SO₃, MgO, and borax to form an aqueous portion. In further aspects, Na₂SO₃ and borax are combined first followed by adding the glycerol containing component, with the NaOH being added last to form the aqueous portion. The aqueous portion of the binder reaction mixture is placed on a shaker for 5 minutes. With respect to the W_{A}, the total water content of the binder and wood particle (WP) is targeted at 11%. The ratio of the dry binder to dry wood particle is 13.1:100 (e.g., 13.1 parts per 100 parts of dry WP). The water content to be added to the aqueous portion of the binder reaction mixture is calculated based on the third mixture moisture content, the wood particle moisture and total binder moisture content.

The moisture content of wood particle and polypeptide are measured by a Mettler Toledo moisture balance at 130° C. W_{A} is determined according to Equation 1:

$${W}_{A} = {W}_{T} - {W}_{WP} - {W}_{BF} \qquad ( Equation 1 )$$

W_{A}: Water to be added to the aqueous portion of the binder reaction mixture
W_{T}: Total moisture of the third mixture
W_{WP}: Water in wood particle
W_{BF}: Water in the binder ingredients including water in polyol component, NaOH, optional borax, optional IsoClear 42, optional MgO, optional, Na₂SO₃, and Prolia 200/90

According to protocol 1A, water, the polyol component, NaOH, and optional Na₂SO₃, and borax (Resin 1) is blended and sprayed to the wood particles (WP) and mixed for 2 to 5 minutes or for 5 minutes to allow for sufficient dispersion. This is followed by the addition of the polypeptide-containing component (and MgO, if added) (Resin 2) in a powder form and that mixture is then blended for 0.2 minutes to 2 minutes or 2 minutes. This process is repeated two times to form resinated face and core furnishes, which are stacked, forming a mat.

Alternatively, according to protocol 1B, the polypeptide-containing component (and MgO, if added) (Resin 2) initially includes the wood particle is blended for 0.2-2 minutes. This is followed by blending the polyol component, NaOH, water, and optional Na₂SO₃, and borax (Resin 1), which is then sprayed to the wood particles, which is pretreated with Resin 2 and mixed for 1 minute or for 0.2 to 2 minutes to allow for sufficient dispersion. The two mixtures are then combined and blended for 2 minutes. This process is repeated two times to form resinated face and core furnishes, which are then formed into three layered mat.

A 91.4 cm×91.4 cm Nordberg hot press utilizing a Pressman control system is set at 174° C. to maintain working conditions in a range of from 150-177° C. Typical platen temperatures are 165° C. The combination of the binder and the wood particle described above is uniformly mixed for 2-10 minutes or 5-10 minutes within a Littleford horizontal continuous mixer, available from B&P Littleford, Saginaw, MI, or equivalent apparatus. The face resinated furnishes are then transferred into at forming box, which is placed on top of a release paper lined caul plate situated on a portable table. The furnish was then evenly distributed across the bottom of the forming box. The same procedure repeated to form a core layer and the second face layer. The mat of the three-layer furnish is then evenly formed in the forming box to the desired thickness. A 76.2 cm×76.2 cm metal collar frame is then placed evenly inside the forming box and on top of the mat. A metal cover is then placed into the forming box and used to gently push the collar and wood particle together to create a mat that will be pressed. The forming box is then lifted off the bottom caul plate, leaving the mat and cover standing alone. The metal cover is carefully removed and a second release paper liner placed on top of the mat, followed by a second caul plate. The entire assembly of the two caul plates with the mat sandwiched between them is then transferred into the hot press.

A temperature and pressure probe is inserted into the center of the mat to monitor internal conditions throughout the pressing cycle. The press platens are then slowly closed to a predetermined distance necessary to maintain a particle board thickness of in a range of from 1.8 cm to 2.16 cm with 1.91 cm being the desired measurement. The mat is held for a time (e.g., a “soak time”) in a range of from 30 to 600 seconds or 145 to 245 seconds or 90 to 130 seconds and then bottom platen is slowly lowered within 240 seconds or 30 seconds to release pressure in the particle board. The caul plates and finished particle board are then transferred back onto the movable table. Removing the top caul plate reveals the multi-layered engineered particle board, which is then placed into a cooling rack. The multi-layered engineered particle board is removed and allowed to condition at the proper requirements for testing. After conditioning, the multi-layered engineered particle board is tested for various properties including Modulus of Rupture (MOR), Modulus of Elasticity (MOE), Thickness Swell %, and Internal Bond Strength (IB).

Binder reaction mixture formulations are provided in Table 1. Board processing parameters are provided in Table 2. Each of Boards 1-12 described in Table 2 included two face layers with a core layer located therebetween. The face layers each account for 20 wt % of the total dry weight basis of the respective board before curing. The core layer accounts for 60 wt % of the total dry weight basis of the respective board before curing. As used in Table 2 the data relating to the face layer for each board describes the first and second face layer for each board.

### Working Example 2: Determination of Modulus of Rupture (MOR), Modulus of Elasticity (MOE), Thickness Swell %, and Internal Bond Strength (IB)

The modulus of rupture, modulus of elasticity, thickness swell %, and internal bond strength were determined using modified ASTM D 1037-06a. ASTM D 1037-06a was modified in that the test specimens used were conditioned under 50% relative humidity and at 21.1° C. For each of the multi-layered engineered particle boards the modulus of rupture, modulus of elasticity, thickness swell %, and internal bond strength were determined by taking the respective multi-layered engineered particle boards, each having dimensions of 91.44 cm wide×91.44 cm long with a thickness of 2.08 cm and ultimately generating one or more test specimens from the multi-layered engineered particle boards. Creating the test specimens included cutting down the multi-layered engineered particle boards to create sample multi-layered engineered particle boards. The sample multi-layered engineered particle boards were cut to have dimensions of 76.20 cm wide x 76.20 cm long with a thickness of 2.08 cm.

To determine the modulus of rupture, modulus of elasticity, thickness swell %, and internal bond strength, several test specimens were created from the sample multi-layered engineered particle boards. Creating several test specimens is helpful to account for the properties of the multi-layered engineered particle boards at different orientations and locations (including edge effect). To determine the modulus of rupture and modulus of elasticity, 9 test specimens each having dimensions of 50.80 cm long (with a span length of 45.72 cm)×7.62 cm wide with a thickness of 2.08 cm were created from sample multi-layered engineered particle boards. The modulus of rupture and modulus of elasticity for each test specimen was collected and those values were averaged to yield the modulus of rupture and modulus of elasticity of the multi-layered engineered particle boards. To determine the internal bond strength, 21 test specimens each having dimensions of 5.08 cm long x 5.08 cm wide with a thickness of 2.08 cm were created from sample multi-layered engineered particle boards. The internal bond strength for each test specimen was collected and those values were averaged to yield the internal bond strength of the multi-layered engineered particle boards. To determine the thickness swell %, 3 test specimens each having dimensions of 15.24 cm long x 15.24 cm wide with a thickness of 2.08 cm were created from multi-layered engineered particle boards. The internal bond strength for each test specimen was collected and those values were averaged to yield the thickness swell % of the multi-layered engineered particle boards.

### Working Example 3: Binder Formulations

Three binder formulations were prepared and included the constituents listed in Table 1. All wt % values are relative to the dry weight of the binder formulations constituents.

TABLE 1

| Binder | Prolia | Crude | | | | | |
|---|---|---|---|---|---|---|---|
| Reaction | 200/90 | Glycerol | NaOH | Na₂SO₃ | Na₂B₄O₇•10H₂O | IsoClear | MgO |
| Mixture | (wt %) | (wt %) | (wt %) | (wt %) | (wt %) | 42 (wt %) | (wt %) |
| Face Binder 1 | 66.8 | 20.0 | 6.0 | 2.0 | 5.21 | — | — |
| Core Binder 1 | 66.8 | 20.0 | 6.0 | 2.0 | 5.21 | — | — |
| Face Binder 2 | 66.8 | 20.0 | 6.0 | 2.0 | 5.21 | — | — |
| Core Binder 2 | 66.8 | 20.0 | 6.0 | 2.0 | 5.21 | — | — |
| Face Binder 3 | 66.8 | 20.0 | 6.0 | 2.0 | 5.21 | — | — |
| Core Binder 3 | 66.8 | 20.0 | 6.0 | 2.0 | 5.21 | — | — |
| Face Binder 4 | 66.8 | 20.0 | 6.0 | 2.0 | 5.21 | — | — |
| Core Binder 4 | 67.0 | 19.9 | 6.0 | 1.9 | 5.17 | — | — |
| Face Binder 5 | 66.8 | 20.0 | 6.0 | 2.0 | 5.21 | — | — |
| Core Binder 5 | 66.8 | 20.0 | 6.0 | 2.0 | 5.21 | — | — |
| Face Binder 6 | 66.8 | 20.0 | 6.0 | 2.0 | 5.21 | — | — |
| Core Binder 6 | 66.8 | 20.0 | 6.0 | 2.0 | 5.21 | — | — |
| Face Binder 7 | 66.8 | 20.0 | 6.0 | 2.0 | 5.21 | — | — |
| Core Binder 7 | 62.0 | 22.9 | 6.9 | 2.3 | 5.95 | — | — |
| Face Binder 8 | 66.8 | 20.2 | 5.9 | 2.0 | 5.1 | — | — |
| Core Binder 8 | 67.0 | 20.1 | 5.9 | 2.0 | 5.1 | — | — |
| Face Binder 9 | 66.8 | 20.3 | 5.9 | 2.0 | 5.1 | — | — |
| Core Binder 9 | 66.9 | 20.2 | 5.8 | 2.0 | 5.1 | — | — |
| Face Binder 10 | 58.3 | 22.8 | 6.8 | 2.3 | 5.9 | 3.9 | — |
| Core Binder 10 | 56.8 | 20.0 | 6.0 | 2.0 | 5.2 | 1.0 | — |
| Face Binder 11 | 66.8 | 20.0 | 6.0 | 2.0 | 5.2 | — | — |
| Core Binder 11 | 66.8 | 20.0 | 6.0 | 2.0 | 5.2 | — | — |
| Face Binder 12 | 67.3 | 20.0 | 6.0 | 2.0 | — | — | 4.7 |
| Core Binder 12 | 67.3 | 20.0 | 6.0 | 2.0 | — | — | 4.7 |

TABLE 2

| | | | Binder | | | | | | | | |
|---|---|---|---|---|---|---|---|---|---|---|---|
| | | | Reaction | | | | | | | | |
| | | | Mixture | | | | Moisture | | | | |
| | | | Dose | | | | (wt %) of | Multi- | | | |
| | | | (parts | | | | mixture | Layer | | | |
| | | | per 100 | | | | of wood | Engineered | | | |
| | | | parts of | | | | particles | Particle | | | |
| | | | the dry | | | | and | Board | | | |
| Multi- | | | weight | | Mix | Mix | binder | Moisture | | | |
| Layer | | | of the | | Time | Time | reaction | Content | | | |
| Engineered | | Binder | plurality | | Resin | Resin | mixture, | (wt %) | Press | Platen Input | Soak |
| Particle | | Reaction | of wood | Mixing | 1 | 2 | before | after | Temperature | Temperature | Time |
| Board | Layer | Mixture | particles) | Protocol | (min.) | (min.) | curing | curing | (° C.) | (° C.) | (Seconds) |
| Board 1 | Face | Face Binder 1 | 13.0 | 1A | 5 | 2 | 11.3 | 3.4 | 165.5 | 173.8 | 240 |
| | Core | Core Binder 1 | 13.0 | 1A | 5 | 2 | 7.0 | | | | |
| Board 2 | Face | Face Binder 2 | 13.0 | 1A | 5 | 2 | 10.7 | 4.6 | 165.5 | 173.8 | 180 |
| | Core | Core Binder 2 | 13.0 | 1A | 5 | 2 | 6.6 | | | | |
| Board 3 | Face | Face Binder 3 | 13.0 | 1A | 5 | 2 | 11.2 | 5.2 | 165.5 | 173.8 | 114 |
| | Core | Core Binder 3 | 13.0 | 1A | 5 | 2 | 7.2 | | | | |
| Board 4 | Face | Face Binder 4 | 13.0 | 1B | 5 | 2 | 9.6 | 5.0 | 165.5 | 173.8 | 147 |
| | Core | Core Binder 4 | 13.0 | 1B | 5 | 2 | 8.6 | | | | |
| Board 5 | Face | Face Binder 5 | 13.0 | 1B | 5 | 2 | 9.6 | 5.3 | 165.5 | 173.8 | 162 |
| | Core | Core Binder 5 | 13.0 | 1B | 5 | 2 | 8.5 | | | | |
| Board 6 | Face | Face Binder 6 | 13.0 | 1B | 5 | 2 | 9.7 | 4.7 | 154.4 | 162.7 | 202 |
| | Core | Core Binder 6 | 13.0 | 1B | 5 | 2 | 8.8 | | | | |
| Board 7 | Face | Face Binder 7 | 13.0 | 1B | 5 | 2 | 9.6 | 4.8 | 165.5 | 173.8 | 187 |
| | Core | Core Binder 7 | 14.0 | 1B | 5 | 2 | 9.2 | | | | |
| Board 8 | Face | Face Binder 8 | 13.0 | 1A | 5 | 2 | 10.7 | 4.8 | 165.5 | 173.8 | 160 |
| | Core | Core Binder 8 | 13.0 | 1A | 5 | 2 | 6.7 | | | | |
| Board 9 | Face | Face Binder 9 | 13.0 | 1A | 5 | 2 | 11.4 | 3.8 | 165.5 | 173.8 | 160 |
| | Core | Core Binder 9 | 13.0 | 1A | 5 | 2 | 6.2 | | | | |
| Board 10 | Face | Face Binder 10 | 13.0 | 1B | 1 | 2 | 10.5 | 5.6 | 165.5 | 173.8 | 160 |
| | Core | Core Binder 10 | 13.0 | 1B | 1 | 2 | 10.1 | | | | |
| Board 11 | Face | Face Binder 11 | 13.0 | 1B | 1 | 2 | 10.2 | — | 165.5 | 173.8 | 160 |
| | Core | Core Binder 11 | 13.0 | 1B | 1 | 2 | 10.3 | | | | |
| Board 12 | Face | Face Binder 12 | 13.0 | 1B | 1 | 2 | 9.9 | 6.0 | 165.5 | 173.8 | 160 |
| | Core | Core Binder 12 | 13.0 | 1B | 1 | 2 | 10.0 | | | | |

TABLE 3

| | Internal Bond | Modulus of | Modulus of | Thickness Swell | Thickness Swell | |
|---|---|---|---|---|---|---|
| | Strength | Elasticity | Rupture | % (measured at | % (measured at | Density |
| | (N/mm²) | (N/mm²) | (N/mm²) | 2 hours) | 24 hours) | (g/cm³) |
| Board 1 | —* | —* | —* | —* | —* | —* |
| Board 2 | —* | —* | —* | —* | —* | —* |
| Board 3 | —* | —* | —* | —* | —* | —* |
| Board 4 | 0.18 | 1634 | 8.36 | 37 | 42 | 0.67 |
| Board 5 | 0.24 | 1958 | 9.87 | 38 | 44 | 0.67 |
| Board 6 | 0.28 | 2068 | 9.88 | 42 | 50 | 0.67 |
| Board 7 | 0.36 | 2020 | 10.54 | 34 | 39 | 0.67 |
| Board 8 | — | — | — | — | — | 0.67 |
| Board 9 | — | — | — | — | — | 0.67 |
| Board 10 | 0.29 | — | — | 33 | — | 0.67 |
| Board 11 | 0.22 | — | — | 36 | — | 0.67 |
| Board 12 | 0.21 | — | — | 31 | — | 0.67 |

*Board failed to maintain structure

Binder reaction mixture formulations (Formulas) are provided in Table 4. Each of the engineered wood products included two face layers with a core layer located therebetween—each layer is formed from the respective Formula. The method for forming the respective engineered wood products is the same as used to product Boards 1-12 The face layers each account for 20 wt % of the total dry weight basis of the respective board before curing. The core layer accounts for 60 wt % of the total dry weight basis of the respective board before curing. In each engineered wood product, the compositions of the face layers and core layer are the same (e.g., use the same identified Formula), with the expectation that the wood particles of the face layers have a smaller average particle size than the wood particles of the core layer. The overall density of the engineered wood product is 672.7 kg/m³. However, smaller wood particles in the face layers result in the face layers having a higher density than the core layer. It is expected that the density of the first face layer, second face layer or both is higher than a density of the core layer.

TABLE 4

| | | | | | | | Ground | | | |
|---|---|---|---|---|---|---|---|---|---|---|
| | | | | | | | SF | | | |
| | Prolia | | IsoClear | | | | White | | Prolia | Prolia |
| | 200/90 | GLY | 42% | NaOH | Na₂SO₃ | Borax | Flake | Prolia100/90 | 200/70 | 200/20 |
| | (wt %) | (wt %) | (wt %) | (wt %) | (wt %) | (wt %) | (wt %) | (wt %) | (wt %) | (wt %) |
| Formula 13 (C124) | 60 | 20 | 10 | 3 | 2 | 5 | — | — | — | — |
| Formula 14 (C125) | 60 | 20 | 10 | 3 | 2 | 5 | — | — | — | — |
| Formula 15 (C139) | 57 | 20 | 10 | 6 | 2 | 5 | — | — | — | — |
| Formula 16 (C141) | — | 20 | 10 | 6 | 2 | 5 | 57 | — | — | — |
| Formula 17 (C142) | — | 20 | 10 | 6 | 2 | 5 | — | — | 57 | — |
| Formula 18 (C145) | — | 20 | 10 | 6 | 2 | 5 | 57 | — | — | 57 |
| Formula 19 (147) | 57 | 30 | — | 6 | 2 | 5 | — | — | — | — |
| Formula 20 (150) | — | 30 | — | 6 | 2 | 5 | — | 57 | — | — |
| Formula 21 (C166) | 60 | 30 | — | 3 | 2 | 5 | — | — | — | — |
| Formula 22 (C167) | 60 | 30 | — | 3 | 2 | 5 | — | — | — | — |
| Formula 23 (C168) | 60 | 30 | — | 3 | 2 | 5 | — | — | — | — |
| Formula 24 (C165) | 60 | 30 | — | 3 | 2 | 5 | — | — | — | — |
| Formula 25 (C164) | 60 | 30 | — | 3 | 2 | 5 | — | — | — | — |
| Formula 26 (C169) | 60 | 30 | — | 3 | 2 | 5 | — | — | — | — |
| Formula 27 (C171) | 62 | 30 | — | 3 | 2 | 3 | — | — | — | — |
| Formula 28 (C170) | 62 | 30 | — | 6 | 2 | — | — | — | — | — |
| Formula 29 (C173) | 50 | 40 | — | 3 | 2 | 5 | — | — | — | — |
| Formula 30 (C137) | 67 | 20 | — | 6 | 2 | 5 | — | — | — | — |
| Formula 31 (C138) | 57 | 30 | — | 6 | 2 | 5 | — | — | — | — |
| Formula 32 (C140) | 67 | 20 | — | 6 | 2 | 5 | — | — | — | — |
| Formula 33 (C144) | 57 | 20 | 10 | 6 | 2 | 5 | — | — | — | — |
| Formula 34 (C146) | 47 | 30 | 10 | 6 | 2 | 5 | — | — | — | — |

### Example 4

TABLE 5

| | Formula 13 | Formula 14 | Formula 15 |
|---|---|---|---|
| Soak time, s | 200 | 118 | 118 |
| Press Temp, C. | 160 | 187.7 | 215.7 |
| IB PSI | 52.4 | 62.5 | 88.2 |
| Binder Dose (per 100 parts | 13 | | |
| of the dry weight of the WF | | | |

| | |
|---|---|
| Mat Moisture (wt %) | 11 |
| Protocol | 1A |

Example 4 shows that an increased soak time, increased press temperature, or both can lead to improved internal bond strength in the engineered wood particle board.

### Example 5

TABLE 6

| | Formula | Formula | Formula | Formula |
|---|---|---|---|---|
| | 16 | 15 | 17 | 18 |
| IB PSI | 95 | 88 | 86 | 57 |
| Press Temp, C. | 212 | | | |
| Press Time, s | 118 | | | |
| Binder Dose (per 100 | 13 | | | |
| parts of the dry | | | | |
| weight of the WF | | | | |

| | |
|---|---|
| Mat Moisture (wt %) | 11 |
| Protocol | 1A |

Example 5 shows that increasing the PDI of the polypeptide-containing component leads improved internal bond strength properties of the engineered wood particle board.

### Example 6

TABLE 7

| | Formula 19 | Formula 20 |
|---|---|---|
| Protein Flour | SF200-90 | SF100-90 |
| IB PSI | 67 | 68 |

| | |
|---|---|
| Press Temp, C. | 187.7 |
| Press Time, s | 120 |
| Binder Dose (per 100 parts of the | 13 |
| dry weight of the WF | |
| Mat Moisture (wt %) | 11 |
| Protocol | 1A |

Example 6 shows that the particle size of the polypeptide-containing (100-mesh vs 200-mesh) component used does not significantly affect the internal bond strength of the engineered wood particle board.

### Example 7

TABLE 8

| | Binder Dose (per 100 | | |
|---|---|---|---|
| | parts of the dry | | |
| | weight of the WF) | Protocol | IB, PSI |
| Formula 21 | 7 | 1B | 41.4 |
| Formula 22 | 7 | 1A | 57.8 |
| Formula 23 | 8 | 1B | 60.7 |
| Formula 24 | 9 | 1B | 61.0 |
| Formula 25 | 9 | 1A | 63.9 |
| Formula 26 | 10 | 1B | 69.8 |
| Formula 31 | 13 | 1A | 116 |

| | |
|---|---|
| Press Temp, F. | 212.7 |
| Soak Time, S | 110 |
| Matt Moisture (wt %) | 11 |

Example 7 shows that increased binder dose leads to improved internal bond strength in the engineered wood particle board. Example 26 also shows that at lower binder doses (7 parts per 100 parts of the dry weight of the wood fiver) protocol 2A produced an engineered wood particle board having better internal bond strength in the engineered wood particle board.

### Example 8

TABLE 9

| | Binder Dose | | |
|---|---|---|---|
| | (per 100 parts of | | |
| | the dry weight | GLY | |
| | of the WF) | (wt %) | IB, PSI |
| Formula 25 | 9 | 30% | 64 |
| Formula 29 | 9 | 40% | 60 |
| Formula 30 | 13 | 20% | 86 |
| Formula 31 | 13 | 30% | 116 |

| | |
|---|---|
| Press Temp, C. | 212.7 |
| Press Time, s | 110 |
| Mat Moisture (wt %) | 11 |
| Protocol | 1A |

Example 8 shows that increased GLY content (wt %) leads to engineered wood particle boards having improved internal bond strengths.

### Example 9

TABLE 10

| | Formula | Formula | Formula | Formula |
|---|---|---|---|---|
| | 32 | 15 | 33 | 34 |
| GLY (wt %) | 20 | 20 | 30 | 30 |
| IsoClear 42% (wt %) | 0 | 10 | 0 | 10 |
| IB psi | 99.5 | 88.2 | 88.4 | 87.2 |

| | |
|---|---|
| Press Temp, C. | 212.7 |
| Press Time, s | 118 |
| Binder Dose (per 100 | 13 |
| parts of the dry | |
| weight of the WF) | |
| Mat Moisture % | 11% |
| Protocol | 1A |

Example 9 shows that while including IsoClear 42% with GLY provides engineered wood particle boards having acceptable internal bond strength values, it was possible to produce engineered wood particle boards having acceptable internal bond strength values without including IsoClear 42%.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### EXEMPLARY EMBODIMENTS

The following exemplary embodiments are provided, the numbering of which is not to be construed as designating levels of importance:

Embodiment 1 provides a multi-layer engineered wood product, comprising:
a first face layer:
a second face layer; and
a core layer disposed between the first face layer and the second face layer;
wherein at least one of the first face layer, the second face layer, and the core layer comprise a plurality of wood components and a reaction product of a binder reaction mixture dispersed about the plurality of wood components, the binder reaction being added in a range of from 3 parts to 25 parts per 100 parts of the dry weight of the plurality of wood components, wherein a moisture content of a mixture of the wood components and the binder reaction mixture is in a range of 9 wt % to 20 wt %, the binder reaction mixture comprising:
   an aqueous portion comprising a polyol component that is added in a range of from 5 wt % to 65 wt % or 5 wt % to 50 wt % based on the dry weight of the binder reaction mixture, the polyol component comprising:
      glycerol,
      an oligomer of glycerol,
      optionally, a monosaccharide,
      optionally, sucrose, or
      optionally, a mixture thereof;
   a polypeptide-containing component that is added in a range of from 20 wt % to 85 wt % based on the dry weight of the binder reaction mixture, the polypeptide-containing component comprising a vegetable protein,
   a base in a range of from 1 to 15 wt % based on the dry weight of the binder reaction mixture:
   optionally, a tackifier in a range of from 0.001 wt % to 1.5 wt %, based on a dry weight of the binder reaction mixture;
   optionally, sodium trimetaphosphate in a range of from 0.1 wt % to 10 wt %, based on a dry weight of the binder reaction mixture;
   optionally, sodium sulfite, sodium bisulfite, sodium metabisulfite, or a mixture thereof in a range of from 0.5 wt % to 10 wt % based on a dry weight of the binder reaction mixture; and
   optionally, borax in a range of from 1 wt % to 15 wt % based on the dry weight of the binder reaction mixture.

Embodiment 2 provides the multi-layer engineered wood product of Embodiment 1, wherein the first face layer and the second face layer comprise the reaction product of the binder reaction mixture dispersed about the plurality of wood products and the core layer is free of the binder reaction mixture dispersed about the plurality of wood products.

Embodiment 3 provides the multi-layer engineered wood product of Embodiment 2, wherein the first face layer and the second face layer comprise the binder reaction mixture, wherein the mixture of the wood components and binder reaction mixture of the first face layer and the mixture of the wood components and binder reaction mixture of the second face layer comprise a similar chemical composition and optionally comprise a moisture content within 1% of each other.

Embodiment 4 provides the multi-layer engineered wood product of Embodiment 1, wherein the first face layer and the second face layer comprise the binder reaction mixture, wherein the mixture of the wood components and binder reaction mixture of the first face layer and the mixture of the wood components and binder reaction mixture of the second face layer comprise a different chemical composition and optionally comprise a moisture content within 1% of each other.

Embodiment 5 provides the multi-layer engineered wood product of any one of Embodiments 1-4, wherein the core layer is free of a reaction product of the binder reaction mixture and comprises a urea-formaldehyde binder or a methylene diphenyl diisocyanate binder or a polyamide-epichlorohydrin based binder.

Embodiment 6 provides the multi-layer engineered wood product of Embodiment 1, wherein the first face layer, the second face layer, and the core layer comprise the reaction product of the binder reaction mixture dispersed about the plurality of wood products.

Embodiment 7 provides the multi-layer engineered wood product of Embodiment 1, wherein the core layer comprises the reaction product of the binder reaction mixture dispersed about the plurality of wood products and the first face layer, second face layer, or both are free of the binder reaction mixture.

Embodiment 8 provides the multi-layer engineered wood product of any of Embodiments 1-7, wherein the polypeptide-containing component comprises soy flour, soy meal, pea protein, soy protein, or a mixture thereof.

Embodiment 9 provides the multi-layer engineered wood product of Embodiment 6, wherein at least two of the mixture of the wood components and binder reaction mixture of the first face layer, the mixture of the wood components and binder reaction mixture of the second face layer, and the mixture of the wood components and binder reaction mixture of the core layer comprise a different chemical composition and optionally comprise a different moisture content (e.g., greater than 1% different).

Embodiment 10 provides the multi-layer engineered wood product of any one of Embodiments 6, and 8-9, wherein each of the mixture of the wood components and binder reaction mixture of the first face layer, the mixture of the wood components and binder reaction mixture of the second face layer, and the mixture of the wood components and binder reaction mixture of the core layer comprise a different chemical composition and optionally comprise a different moisture content (e.g., greater than 1% different).

Embodiment 11 provides the multi-layer engineered wood product of any one of Embodiments 1-10, wherein the moisture content of the mixture of the wood components and binder reaction mixture is in a range of 9.0 wt % to 16 wt %.

Embodiment 12 provides the multi-layer engineered wood product of any one of Embodiments 1-11, wherein the aqueous portion further comprises 1 wt % to 12 wt % of the base, based on a dry weight of the binder reaction mixture.

Embodiment 13 provides the multi-layer engineered wood product of

Embodiments 1-12, wherein a pH of the aqueous portion is greater than 9 (for example 9 to 14).

Embodiment 14 provides the multi-layer engineered wood product of any one of Embodiments 1-13, wherein the pH of the aqueous portion is from 9 to 13.5.

Embodiment 15 provides the multi-layer engineered wood product of any one of Embodiments 1-14, wherein the pH of the aqueous portion is from 10 to 13 (for example, 11 to 13).

Embodiment 16 provides the multi-layer engineered wood product of any one of Embodiments 1-15, wherein the polyol component is in a range of from 10 wt % to 50 wt % (for example, 20 wt % to 50 wt %), based on a dry weight of the binder reaction mixture.

Embodiment 17 provides the multi-layer engineered wood product of any one of Embodiments 1-16, wherein the polyol component is in a range of from 20 wt % to 40 wt % (for example, 20 wt % to 30 wt %), based on a dry weight of the binder reaction mixture.

Embodiment 18 provides the multi-layer engineered wood product of any one of Embodiments 1-17, wherein the sodium sulfite, sodium bisulfite, sodium metabisulfite, or the mixture thereof is in a range of from 0.5 wt % to 10 wt %, based on a dry weight of the binder reaction mixture.

Embodiment 19 provides the multi-layer engineered wood product of any one of Embodiments 1-18, wherein the binder reaction mixture comprises less than 5 wt % of urea-formaldehyde, methylene diphenyl diisocyanate, or a polyamide-epichlorohydrin based binder, or a mixture thereof.

Embodiment 20 provides the multi-layer engineered wood product of any one of Embodiments 1-19, wherein the binder reaction mixture is substantially free (e.g., comprises less than 1 wt %) of urea-formaldehyde, methylene diphenyl diisocyanate, or a polyamide-epichlorohydrin based binder, or a mixture thereof.

Embodiment 21 provides the multi-layer engineered wood product of any one of Embodiments 1-20, wherein the binder reaction mixture of each individual layer is added in a range of from 5 parts to 20 parts per 100 parts of the dry weight of the plurality of wood components of each of the first face layer, the second face, layer, the core layer, or a combination thereof.

Embodiment 22 provides the multi-layer engineered wood product of any one of Embodiments 1-21, wherein the binder reaction mixture of each individual layer is added in a range of from 6 parts to 17 parts or 8 parts to 17 parts per 100 parts of the dry weight of the plurality of wood components of each of the first face layer, the second face, layer, the core layer, or a combination thereof.

Embodiment 23 provides the multi-layer engineered wood product of any one of Embodiments 1-22, wherein the borax is in a range of from 3 wt % to 6 wt %, based on the dry weight of the binder reaction mixture.

Embodiment 24 provides the multi-layer engineered wood product of any one of Embodiments 1-23, wherein a modulus of rupture of the multi-layered engineered wood product is in a range of from 10 N/mm² to 20 N/mm².

Embodiment 25 provides the multi-layer engineered wood product of any one of Embodiments 1-24, wherein a modulus of rupture of the multi-layered engineered wood product is in a range of from 12 N/mm² to 17 N/mm².

Embodiment 26 provides the multi-layer engineered wood product of any one of Embodiments 1-25, wherein a thickness swell % of the multi-layered engineered wood product measured after soaking the multi-layered engineered wood product in water for two hours is in a range of from 5% to 45%.

Embodiment 27 provides the multi-layer engineered wood product of any one of Embodiments 1-26, wherein a thickness swell % of the multi-layered engineered wood product measured after soaking the multi-layered engineered wood product in water for two hours is in a range of from 5% to 40% (for example, 5% to 35% or 10% to 30%).

Embodiment 28 provides the multi-layer engineered wood product of any one of Embodiments 1-27, wherein a modulus of elasticity of the multi-layered engineered wood product is in a range of from 1,378 N/mm² to 2,413 N/mm².

Embodiment 29 provides the multi-layer engineered wood product of any one of Embodiments 1-28, wherein a modulus of elasticity of the multi-layered engineered wood product is in a range of from 1,930 N/mm² to 2,137 N/mm² (for example, 1,965 N/mm² to 2,033 N/mm²).

Embodiment 30 provides the multi-layer engineered wood product of any one of Embodiments 1-29, wherein an internal bond strength of the multi-layered engineered wood product is in a range of from 0.1 N/mm² to 0.83 N/mm².

Embodiment 31 provides the multi-layer engineered wood product of any one of Embodiments 1-30, wherein an internal bond strength of the multi-layered engineered wood product is in a range of from 0.2 N/mm² to 0.5 N/mm².

Embodiment 32 provides the multi-layer engineered wood product of any one of Embodiments 1-31, wherein a moisture layer of each of the binder reaction mixtures of each of the first face layer, the second face layer, and the core layer is in a range of from 9 wt % to 20 wt %.

Embodiment 33 provides the multi-layer engineered wood product of any one of Embodiments 1-32, wherein a moisture layer of each of the binder reaction mixtures of each of the first face layer, the second face layer, and the core layer is in a range of from 9.5 wt % to 16 wt %.

Embodiment 34 provides the multi-layer engineered wood product of any one of Embodiments 1-33, wherein a moisture layer of each of the binder reaction mixtures of each of the first face layer, the second face layer, and the core layer is in a range of from 9.5 wt % to 11 wt %.

Embodiment 35 provides the multi-layer engineered wood product of any one of Embodiments 1-34, wherein a density of the multi-layer engineered wood product is in a range of from 0.2 g/cm³ to 0.8 g/cm³ or 0.60 g/cm³ to 0.75 g/cm³.

Embodiment 36 provides the multi-layer engineered wood product of any one of Embodiments 32-35, wherein the reaction product of the binder reaction mixture is homogenously distributed about the plurality of wood components.

Embodiment 37 provides the multi-layer engineered wood product of any one of Embodiments 1-37, wherein the sodium trimetaphosphate is in a range of from 0.4 wt % to 0.9 wt % based on the dry weight of the binder reaction mixture.

Embodiment 38 provides the multi-layer engineered wood product of any one of Embodiments 1-37, wherein the sodium trimetaphosphate is in a range of from 0.6 wt % to 0.8 wt % based on the dry weight of the binder reaction mixture.

Embodiment 39 provides a method of making a multi-layer engineered wood product, the method comprising:
(a) mixing:
   a polyol component comprising:
      glycerol,
      an oligomer of glycerol,
      a monosaccharide,
      sucrose, or
      a mixture thereof:
   water:
   a base:
   optionally a tackifier:
   optionally, sodium trimetaphosphate:
   optionally sodium sulfite, sodium bisulfite, sodium metabisulfite, or a mixture thereof; and
   optionally borax:
   to produce a first mixture:
(b) mixing the first mixture produced at (a) with a plurality of wood components to obtain a second mixture or mixing the plurality of wood components with a polypeptide-containing component comprising a vegetable protein to obtain a third mixture:
(c) mixing the second mixture produced at (b) with a polypeptide-containing component comprising a vegetable protein to form a fourth mixture or mixing the third mixture produced at (b) with the first mixture produced at (a) to form a fifth mixture to form a first multi-layered engineered wood precursor; and
(d) repeating (a)-(c) at least once to form a second multi-layered engineered wood precursor
(e) stacking the first multi-layered engineered wood precursor and the second multi-layered engineered wood precursor with a third multi-layered engineered wood precursor, the third multi-layered engineered wood precursor, optionally, formed according to (a)-(c); and
(f) curing the first multi-layered engineered wood precursor, second multi-layered engineered wood precursor, and third multi-layered engineered wood precursor.

Embodiment 40 provides the method of Embodiment 39, further comprising mixing the plurality of wood components with a swell-retardant component.

Embodiment 41 provides the method of any one of Embodiments 39 or 40, wherein the polyol component is in a range of from 5 wt % to 65 wt % or 5 wt % to 50 wt %, based on the dry weight of the first mixture.

Embodiment 42 provides the method of any one of Embodiments 39-41, wherein the mixing of (b) comprises spraying the first mixture on the plurality of wood components.

Embodiment 43 provides the method of any one of Embodiments 39-42, wherein the polypeptide-containing component at (c) is in a powder form.

Embodiment 44 provides the method of any one of Embodiments 39-43, further comprising mixing sodium sulfite, sodium bisulfite, sodium metabisulfite, or a mixture thereof at (a), (b) (c), or a combination thereof.

Embodiment 45 provides the method of any one of Embodiments 39-44, wherein the first mixture produced at (a) is aqueous and the polyol component is in a range of from 20 wt % to 50 wt % based on the dry weight of the first mixture.

Embodiment 46 provides the method of any one of Embodiments 39-45, wherein the first mixture produced at (a) is aqueous and the polyol component in a range of from 20 wt % to 30 wt % based on the dry weight of the first mixture.

Embodiment 47 provides the method of any one of Embodiments 39-46, wherein the first mixture produced at (a) is aqueous and comprises 1 wt % to 15 wt % of the base based on the dry weight of the first mixture, wherein a pH of the second mixture or the third mixture produced at (b) greater than 10.

Embodiment 48 provides the method of any one of Embodiment 39-47, wherein the polypeptide-containing component comprises soy flour, soy meal, soy protein, pea protein wheat gluten, corn protein isolate, or a mixture thereof, and is in a range of from 20 wt % to 85 wt % based on the dry weight of the first mixture.

Embodiment 49 provides the method of any one of Embodiment 39-48, wherein the polypeptide-containing component comprises soy flour, wheat gluten, corn protein isolate, or a mixture thereof and is in a range of from 30 wt % to 80 wt %, based on the first mixture.

Embodiment 50 provides the method of any one of Embodiments 39-49, wherein the polypeptide-containing component comprises soy flour, wherein the soy flour is from 40 wt % to 65 wt % protein, based on the total soy flour added.

Embodiment 51 provides the method of any one of Embodiments 39-50, wherein the polypeptide-containing component comprises soy flour and comprises from 20 wt % to 85 wt %, based on the dry weight of the first mixture.

Embodiment 52 provides the method of any one of Embodiments 39-51, wherein the mixture(s) produced at (a), (b), (c), or a combination thereof is substantially free (e.g., less than 1 wt %) of urea-formaldehyde, methylene diphenyl diisocyanate, or a polyamide-epichlorohydrin based binder, or a mixture thereof.

Embodiment 53 provides the method of any one of Embodiments 39-52, wherein the mixture(s) produced at (a), (b), (c), or a combination thereof further comprises sodium sulfite, sodium bisulfite, sodium metabisulfite, or a mixture thereof.

Embodiment 54 provides the method of any one of Embodiments 39-53, wherein the mixture(s) produced at (a), (b), (c), or a combination thereof further comprises borax, for example sodium tetraborate decahydrate (or sodium tetraborate octahydrate), sodium tetraborate pentahydrate, and/or anhydrous sodium tetraborate.

Embodiment 55 provides the method of Embodiment 54, wherein the borax is in a range of from 1 wt % to 15 wt %, based on the dry weight of the first mixture.

Embodiment 56 provides the method of any one of Embodiments 53 or 54, wherein the borax is in a range of from 3 wt % to 6 wt %, based on the dry weight of the first mixture.

Embodiment 57 provides the method of any one of Embodiments 39-56, wherein curing at (f) is performed at a temperature of 100° C. to 250° C. (for example, at least 198° C., at least 204° C., at least 246° C. in a range of from 198° C. to 232° C., 204° C. to 226° C., 210° C. to 221° C., less than 315° C., or preferably less than 230° C. or, for example, in a range of from 204° C. to 248° C., 210° C. to 243° C., 210° C. to 226° C., at least 215° C., or at least 251° C.).

Embodiment 58 provides the method of any one of Embodiments 39-57, wherein the sodium trimetaphosphate is in a range of from 0.1 wt % to 10 wt %, based on a dry weight of the first mixture.

Embodiment 59 provides the method of any one of Embodiments 39-58, wherein the sodium trimetaphosphate is in a range of from 0.6 wt % to 0.8 wt % based on a dry weight of the first mixture.

Embodiment 60 provides the method of any one of Embodiments 39-59, wherein the sodium trimetaphosphate is in a range of from 0.1 wt % to 1 wt % based on a dry weight of the first mixture.

Embodiment 61 provides the multi-layer engineered wood product of any one of Embodiments 1-38 or the method of any one of Embodiments 39-60, wherein the base comprises NaOH, KOH, magnesium oxide, or a mixture thereof.

Embodiment 62 provides the multi-layer engineered wood product of any one of Embodiments 1-38 and 61 or the method of any one of Embodiments 39-61, wherein the base comprises NaOH.

Embodiment 63 provides the multi-layer engineered wood product of any one of Embodiments 1-38 and 61-62 or the method of any one of Embodiments 39-62, wherein the tackifier comprises sucrose, pine rosin, starch.

Embodiment 64 provides the multi-layer engineered wood product of any one of Embodiments 1-38 and 61-63 or the method of any one of Embodiments 39-64, wherein the polypeptide-containing component comprises a plant protein, a soy flour, linseed flour, flaxseed flour, cottonseed flour, canola flour, sunflower flour, peanut flour, lupin flour, pea flour, a com protein, and mixtures thereof.

Embodiment 65 provides the multi-layer engineered wood product of any one of Embodiments 1-38 and 61-64 or the method of any one of Embodiments 39-64, wherein the polypeptide-containing component comprises a soy flour.

Embodiment 66 provides the multi-layer engineered wood product of any one of Embodiments 1-38 and 61-65 or the method of any one of Embodiments 39-65, wherein the polypeptide-containing component comprises soy flour, wherein the soy flour comprises from 40 wt % to 65 wt % protein, based on the total soy flour added.

Embodiment 67 provides the multi-layer engineered wood product or the method of Embodiment 66, wherein the polypeptide-containing component comprises soy flour wherein the soy flour is from 20 wt % to 85 wt % of the binder reaction mixture based on the dry weight thereof.

Embodiment 68 provides the multi-layer engineered wood product of any one of any one of Embodiments 1-38 and 61-67 or the method of any one of Embodiments 39-67, wherein the soy flour is from 30 wt % to 80 wt % of the dry weight the binder reaction mixture.

Embodiment 69 provides the multi-layer engineered wood product of any one of any one of Embodiments 1-38 and 61-69 or the method of any one of Embodiments 39-63, wherein the soy flour has a protein dispersibility index (PDI) of at least 60.

Embodiment 70 provides the multi-layer engineered wood product of any one of Embodiments 1-38 and 61-69 or the method of any one of Embodiments 39-69, wherein the soy flour has a protein dispersibility index (PDI) in a range of from 70 to 95, for example a PDI from 80 to 90.

Embodiment 71 provides the multi-layer engineered wood product of any one of any one of Embodiments 1-38 and 61-70 or the method of any one of Embodiments 39-70, wherein the polypeptide-containing component is passable through a screen size 100-mesh screen to a 635-mesh screen.

Embodiment 72 provides the multi-layer engineered wood product of any one of any one of Embodiments 1-38 and 61-41 or the method of any one of Embodiments 39-71, wherein the polypeptide-containing component can pass through a screen size 100-mesh screen to a 400-mesh screen, for example, a screen size of from 150 to 325.

Embodiment 73 provides the multi-layer engineered wood product of any one of any one of Embodiments 1-38 and 61-72 or the method of any one of Embodiments 39-72, wherein the plurality of wood components comprise one or more strands, one or more particles, one or more fibers, or a mixture thereof.

Embodiment 74 provides the multi-layer engineered wood product of any one of any one of Embodiments 1-38 and 61-73 or the method of any one of Embodiments 39-73, wherein the polyol component comprises a glucose syrup, high fructose corn syrup, or a mixture thereof.

Embodiment 75 provides the multi-layer engineered wood product of any one of Embodiments 1-38 and 61-74 or the method of any one of Embodiments 39-74, wherein the mixture of the wood components and the binder reaction mixture of the core layer has a moisture content of at least 9 wt % and a moisture content of the mixture of the wood components and the binder reaction mixture of the first face layer and the second face are each greater than the moisture content of the mixture of the wood components and the binder reaction mixture of core laver.

Embodiment 76 provides the multi-layer engineered wood product of any one of Embodiments 1-38 and 61-74 or the method of any one of Embodiments 39-74, wherein the mixture of the wood components and the binder reaction mixture of the core layer has a moisture content of at least 9 wt % and a moisture content of the mixture of the wood components and the binder reaction mixture of the first face layer and the second face are each less than the moisture content of the mixture of the wood components and the binder reaction mixture of core layer.

Embodiment 77 provides the multi-layer engineered wood product of any one of any one of Embodiments 1-38 and 61-76 or the method of any one of Embodiments 39-76, wherein the polyol component comprises fructose, sucrose, or glucose, or a mixture thereof.

Embodiment 78 provides the multi-layer engineered wood product of any one of any one of Embodiments 1-38 and 61-77, or the method of any one of Embodiments 39-77, wherein the multi-layered engineered wood product comprises a particle board, a medium density fiber board, a high density fiberboard, an oriented strand board, an multi-layered engineered wood flooring, or a combination thereof.

Embodiment 79 provides the multi-layer engineered wood product of any one of any one of Embodiments 1-38 and 61-78 or the method of any one of Embodiments 39-78, wherein the multi-layered engineered wood product comprises a particle board.

Embodiment 80 provides the multi-layer engineered wood product, of any one of Embodiments 1-38 and 61-79, wherein a viscosity of the aqueous portion at 25° C. is in a range of 5 cP to 1000 cP.

Embodiment 81 provides the multi-layer engineered wood product, of any one of Embodiments 1-38 and 61-80, wherein a viscosity of the aqueous portion at 25° C. is in a range of 10 cP to 500 cP or from 10 cP to 100 cP.

Embodiment 82 provides the method of any one of Embodiments 39-79, wherein a viscosity of the first mixture at 25° C. is in a range of 5 cP to 1000 cP.

Embodiment 83 provides the method of any one of Embodiments 39-79 and 82, wherein a viscosity of the first mixture at 25° C. is a range of 10 cP to 500 cP or from 10 cP to 100 cP.

1.-38. (canceled)

39. A method of making a multi-layer engineered wood product, the method comprising:
(a) mixing:
a polyol component comprising:
glycerol;
water;
a base;
optionally a tackifier;
optionally, sodium trimetaphosphate;
optionally sodium sulfite, sodium bisulfite, sodium metabisulfite, or a mixture thereof; and
optionally borax;
to produce a first mixture;
(b) mixing the first mixture produced at (a) with a plurality of wood components to obtain a second mixture or mixing the first mixture produced at (a) with a polypeptide-containing component comprising a vegetable protein to obtain a third mixture;
(c) mixing the second mixture produced at (b) with a polypeptide-containing component comprising a vegetable protein to form a fourth mixture or mixing the third mixture produced at (b) with a plurality of wood components to form a fifth mixture to form a first multi-layered engineered wood precursor; and
(d) repeating (a)-(c) at least once to form a second multi-layered engineered wood precursor
(e) stacking the first multi-layered engineered wood precursor and the second multi-layered engineered wood precursor with a third multi-layered engineered wood precursor, the third multi-layered engineered wood precursor, optionally, formed according to (a)-(c); and
(f) curing the first multi-layered engineered wood precursor, second multi-layered engineered wood precursor, and third multi-layered engineered wood precursor.

40. A method of making a multi-layer engineered wood product, the method comprising:
(a) mixing:
a polyol component comprising:
glycerol;
water;
a base;
optionally a tackifier;
optionally, sodium trimetaphosphate;
optionally sodium sulfite, sodium bisulfite, sodium metabisulfite, or a mixture thereof; and
optionally borax;
to produce a first mixture;
(b) mixing the first mixture produced at (a) with a plurality of wood components to obtain a second mixture or mixing the plurality of wood components with a polypeptide-containing component comprising a vegetable protein to obtain a third mixture;
(c) mixing the second mixture produced at (b) with a polypeptide-containing component comprising a vegetable protein to form a fourth mixture or mixing the third mixture produced at (b) with the first mixture produced at (a) to form a fifth mixture to form a first multi-layered engineered wood precursor; and
(d) repeating (a)-(c) at least once to form a second multi-layered engineered wood precursor
(e) stacking the first multi-layered engineered wood precursor and the second multi-layered engineered wood precursor with a third multi-layered engineered wood precursor, the third multi-layered engineered wood precursor, optionally, formed according to (a)-(c); and
(f) curing the first multi-layered engineered wood precursor, second multi-layered engineered wood precursor, and third multi-layered engineered wood precursor.

41. The method of claim 40, further comprising mixing the plurality of wood components with a swell-retardant component.

42. The method of claim 40, wherein the polyol component is in a range of from 5 wt % to 50 wt %, based on the dry weight of the first mixture.

43. The method of claim 40, wherein the mixing of (b) comprises spraying the first mixture on the plurality of wood components.

44. The method of claim 40, wherein the polypeptide-containing component at (c) is in a powder form.

45. The method of claim 40, further comprising mixing sodium sulfite, sodium bisulfite, sodium metabisulfite, or a mixture thereof at (a), (b) (c), or a combination thereof.

46. (canceled)

47. (canceled)

48. The method of claim 40, wherein the first mixture produced at (a) is aqueous and comprises 1 wt % to 15 wt % of the base based on the dry weight of the first mixture, wherein a pH of the second mixture or the third mixture produced at (b) greater than 10.

49. The method of claim 40, wherein the polypeptide-containing component comprises soy flour, soy meal, soy protein, pea protein wheat gluten, corn protein isolate, or a mixture thereof, and is in a range of from 20 wt % to 85 wt % based on the dry weight of the first mixture.

50. (canceled)

51. The method of claim 40, wherein the polypeptide-containing component comprises soy flour, wherein the soy flour is from 40 wt % to 65 wt % protein, based on the total soy flour added.

52. The method of claim 40, wherein the polypeptide-containing component comprises soy flour and comprises from 20 wt % to 85 wt %, based on the dry weight of the first mixture.

53. The method of claim 40, wherein the mixture(s) produced at (a), (b), (c), or a combination thereof is substantially free (e.g., less than 1 wt %) of urea-formaldehyde, methylene diphenyl diisocyanate, or a polyamide-epichlorohydrin based binder, or a mixture thereof.

54. The method of claim 40, wherein the mixture(s) produced at (a), (b), (c), or a combination thereof further comprises sodium sulfite, sodium bisulfite, sodium metabisulfite, or a mixture thereof.

55. The method of claim 40, wherein the mixture(s) produced at (a), (b), (c), or a combination thereof further comprises borax, for example sodium tetraborate decahydrate (or sodium tetraborate octahydrate), sodium tetraborate pentahydrate, and/or anhydrous sodium tetraborate.

56. The method of claim 55, wherein the borax is in a range of from 1 wt % to 15 wt %, based on the dry weight of the first mixture.

57. The method of claim 55, wherein the borax is in a range of from 3 wt % to 6 wt %, based on the dry weight of the first mixture.

58. The method of claim 40, wherein curing at (f) is performed at a temperature of 100° C. to 250° C. (for example, at least 198° C., at least 204° C., at least 246° C. in a range of from 198° C. to 232° C., 204° C. to 226° C., 210° C. to 221° C., less than 315° C., or preferably less than 230° C. or, for example, in a range of from 204° C. to 248° C., 210° C. to 243° C., 210° C. to 226° C., at least 215° C., or at least 251° C.).

59.-61. (canceled)

62. The method of claim 40, wherein the base comprises NaOH, KOH, magnesium oxide, or a mixture thereof.

63. The method of claim 40, wherein the base comprises NaOH.

64.-79. (canceled)

80. The method of claim 40, wherein the multi-layered engineered wood product comprises a particle board.

81.-88. (canceled)
